(19) United States
(12) Patent Application Publication
(10) Pub. No.: US 2024/0061220 A1
(43) Pub. Date: Feb. 22, 2024

(54) OPTICAL SYSTEM AND CAMERA MODULE

(71) Applicant: Sharp Sensing Technology Corporation, Tenri City (JP)

(72) Inventor: Akihiro IIDA, Tenri City (JP)

(21) Appl. No.: 18/215,963

(22) Filed: Jun. 29, 2023

(30) Foreign Application Priority Data
Aug. 18, 2022 (JP) 2022-130518

(51) Int. Cl. G02B 15/14; G02B 15/28; G02B 17/08

(52) U.S. Cl. CPC G02B 15/143105; G02B 15/28; G02B 17/0896

(57) ABSTRACT

An optical system includes: a first lens group; a second lens group disposed behind the first lens group; and a third lens group disposed behind the second lens group. The optical system satisfies: −6.0<f/f2<−2.0; ih/f<0.4; 0.7<TTL/f<1.0; 1.6<Fno/7.0; and Ims/d−OIS>1.5 where ih: a maximum image height of the first lens group, TTL: a distance from a surface of a lens to an image forming surface, Fno: an F number of the first lens group, d−OIS: an absolute value of a distance for which the second lens group is driven in the direction perpendicular to the optical axis, and Ims: an absolute value of a distance for which the image moves in the direction perpendicular to the optical axis on the image plane.

### CROSS-REFERENCE TO RELATED APPLICATIONS

The present disclosure relates to an optical system and a camera module. This application claims the benefit of priority to Japanese Patent Application Number 2022-130518 filed on Aug. 18, 2022. The entire contents of the above-identified application are hereby incorporated by reference.

### BACKGROUND

### Technical Field

Japanese Patent No. 5611533 discloses a camera module. The camera module includes: a plurality of imaging lenses; a lens barrel; and a lens drive device. The plurality of imaging lenses form a subject image. The lens barrel holds the plurality of imaging lenses. The lens drive device drives an optical unit, including the plurality of imaging lenses and the lens barrel, in an optical axis

direction. This is how the camera module carries out an autofocus function (AF) (paragraphs [0052], [0054], and [0055]). Hence, the camera module accomplishes the focusing by extending the lens barrel holding a group of the plurality of imaging lenses; that is, by extending the whole lens group.

Japanese Patent No. 5329629 discloses a camera module. The camera module includes: an imaging lens, a lens barrel; and a lens drive device. The lens barrel houses the imaging lens. The lens drive device integrally drives the imaging lens and the lens barrel in two axial directions perpendicular to an optical axis. Thus, the camera module achieves an image stabilizing function (paragraphs [0021], [0022], and [0026]). Hence, the camera module has an optical image stabilization (OIS) function. As to the camera module, the imaging lens and the lens barrel are integrally driven in a direction perpendicular to the optical axis, such that an object image to be formed on an image plane can also be moved in the direction perpendicular to the optical axis. Hence, the camera module controls a position of the object image so that the object image moves on with the camera shake. This is how the OIS function is accomplished.

U.S. Pat. No. 10,371,928 discloses a low-profile foldable camera module. The low-profile foldable camera module includes: a lens module; and a lens-actuation subassembly. The lens module includes a plurality of lens elements. The plurality of lens elements are held inside the lens module. The lens-actuation subassembly moves the lens module along a Z-axis parallel with the optical axis. This is how the AF function is accomplished. Hence, focusing of the low-profile foldable camera module is performed by extending the lens module holding therein the plurality of lens elements; that is, by extending the whole lens group. The lens-actuation subassembly also generates a Y-motion for the OIS. Thus, the OIS performance can be achieved (paragraphs [0021], [0070], [0071], [0100], and [0101]). The low-profile foldable camera module includes a reflective element. The reflective element is either a mirror or a prism. The reflective element reflects light from a first optical path to a second optical path that converges on an optical axis of the lens module. If the low-profile foldable camera module is included in a smartphone, the reflective element deflects a propagation direction of light from a direction perpendicular to the back surface of the smartphone to a direction parallel with the back surface. Such a configuration can reduce the thickness of the smartphone (paragraphs [0005], [0011], [0069], [0071], and [0075]).

### SUMMARY

The camera module disclosed in Japanese Patent No. 5611533 needs to have a clearance by an extending distance for the lens drive device to move the lens barrel in the direction of the optical axis when the whole lens group extends.

The clearance inevitably increases the size of the camera module, making it difficult to reduce the size and thickness of the camera module. This problem is particularly apparent when the camera module includes a telephoto lens having a long focal point, and has a large extending distance.

In order to solve this problem, a camera module performing focusing by extending the whole lens group includes a reflective element as seen in the low-profile camera module disclosed in U.S. Pat. No. 10,371,928. In such a case, the camera module needs the above clearance between the imaging unit and the reflective element. In the clearance, a light ray spreads out. The spreading light ray is sized according to an angle of view of the camera module. For this reason, the reflective element is large. The large reflective element inevitably increases the size of the camera module, making it difficult to reduce the size and thickness of the camera module.

Furthermore, the camera module disclosed in Japanese Patent No. 5329629 needs to drive the imaging lens in the direction perpendicular to the optical axis. If the camera module includes a telephoto lens, which has a long focal point, the imaging lens needs to be driven in a long distance in the direction perpendicular to the optical axis. The long driving distance inevitably increases the size of the camera module, making it difficult to reduce the size and thickness of the camera module.

The present disclosure is devised to overcome the above problems. An aspect of the present disclosure is intended to reduce sizes and thicknesses of, for example, an optical system and a camera module.

An optical system according to an aspect of the present disclosure includes: a first lens group including two or more lenses, having positive power as a whole, and transmitting object light; a second lens group including at least one first lens, having negative power as a whole, disposed behind the first lens group, and transmitting the object light; a third lens group including at least one second lens, having positive power as a whole, disposed behind the second lens group, and collecting the object light on an imaging unit; and a lens drive device configured to drive the second lens group in a direction perpendicular to an optical axis of the optical system. in focusing on an object found at a short distance and emitting the object light, no change is observed in a distance between the third lens group and the imaging unit in a direction of the optical axis. If the second lens group is driven in the direction perpendicular to the optical axis, an image moves on an image plane of the optical system in the direction perpendicular to the optical axis. The optical system satisfies: −6.0<f/f2<−2.0; ih/f<0.4; 0.7<TTL/f<1.0; 1.6<Fno/7.0; and Ims/d−OIS>1.5 where f: an actual focal point of the first lens group, the second lens group, and the third lens group as a whole, f2: a focal point of the second lens group, ih: a maximum image height of the first lens group, the second lens group, and the third lens group as a whole, TTL: a distance from a surface of a lens to an image forming surface, the surface facing the object and the lens being included in the two or more lenses and disposed closest to the object, Fno: an F number of the first lens group, the second lens group, and the third lens group as a whole, d−OIS: an absolute value of a distance for which the second lens group is driven in the direction perpendicular to the optical axis, and Ims: an absolute value of a distance for which the image moves in the direction perpendicular to the optical axis on the image plane, the image moving when the second lens group is driven in the direction perpendicular to the optical axis. A camera module according to another aspect of the present disclosure includes: the optical system according to the aspect of the present disclosure; and the imaging unit. The imaging unit has an imaging forming surface on which the object light is collected, and photoelectrically converts the object light.

### BRIEF DESCRIPTION OF DRAWINGS

FIG. 1 is a perspective view schematically illustrating a camera module of a first embodiment;

FIG. 2 is a cross-sectional view schematically illustrating a cross-section of the camera module of the first embodiment, taken along line A-A in FIG. 1;

FIG. 3 is a block diagram of a control system included in the camera module of the first embodiment;

FIG. 4A is a configuration diagram of an optical system included in the camera module of the first embodiment when the optical system focuses at infinity;

FIG. 4B is a configuration diagram of the optical system included in the camera module of the first embodiment when the optical system focuses at 500 mm;

FIG. 5A is a configuration diagram of the optical system included in the camera module of the first embodiment when the optical system is in a normal position;

FIG. 5B is a configuration diagram of the optical system included in the camera module according to the first embodiment when image stabilization is performed on the optical system;

FIG. 6A is a configuration diagram of an optical system included in a camera module of a second embodiment when the optical system focuses at infinity;

FIG. 6B is a configuration diagram of the optical system included in the camera module of the second embodiment when the optical system focuses at 500 mm;

FIG. 7A is a configuration diagram of the optical system included in the camera module of the second embodiment when the optical system is in a normal position;

FIG. 7B is a configuration diagram of the optical system included in the camera module according to the second embodiment when image stabilization is performed on the optical system;

FIG. 8A is a configuration diagram of an optical system included in a camera module of a third embodiment when the optical system focuses at infinity;

FIG. 8B is a configuration diagram of the optical system included in the camera module of the third embodiment when the optical system focuses at 500 mm;

FIG. 9A is a configuration diagram of the optical system included in the camera module of the third embodiment when the optical system is in a normal position;

FIG. 9B is a configuration diagram of the optical system included in the camera module of the third embodiment when image stabilization is performed on the optical system;

FIG. 10 is a block diagram of a control system included in a camera module of a fourth embodiment;

FIG. 11 is a perspective view schematically illustrating a camera module of a first comparative example;

FIG. 12 is a cross-sectional view schematically illustrating a cross-section of the camera module of the first comparative example, taken along line B-B in FIGS. 11; and

FIG. 13 is a perspective view schematically illustrating a camera module of a second comparative example.

### DESCRIPTION OF EMBODIMENTS

Embodiments of the present disclosure will be described below, with reference to the drawings. Note that, throughout the drawings, like reference signs denote identical or similar constituent features. Such features will not be repeatedly elaborated upon.

### 1. First Embodiment

### 1.1 Camera Module

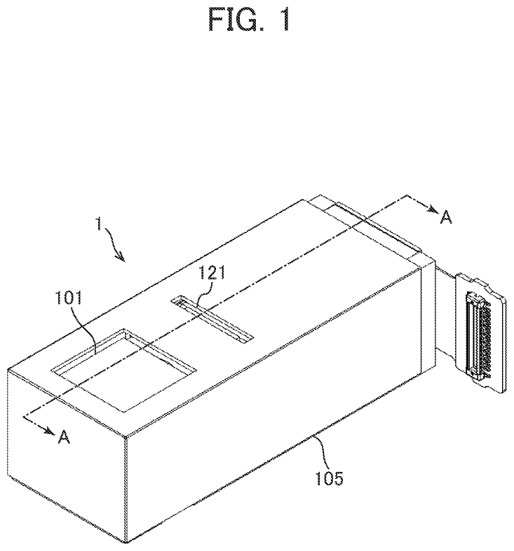

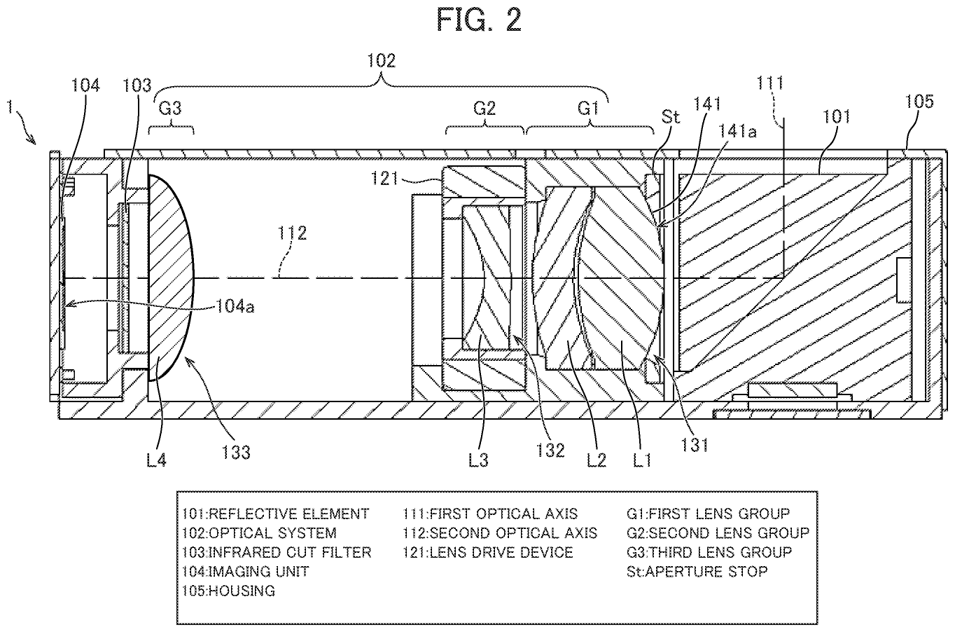

FIG. 1 is a perspective view schematically illustrating a camera module of a first embodiment. FIG. 2 is a cross-sectional view schematically illustrating the camera module of the first embodiment. FIG. 2 illustrates a cross-section taken along line A-A in FIG. 1. FIG. 2 illustrates a cross-section obtained when a center portion of the camera module of the first embodiment is cut along the optical axis of the camera module.

A camera module 1 of the first embodiment illustrated in FIGS. 1 and 2 receives object light emitted from an object, and outputs an electric signal corresponding to the received object light. The camera module 1 is a foldable camera module including a foldable optical system. The camera module 1 performs focusing on an object by inner focusing. The camera module 1 performs optical image stabilization (OIS).

As illustrated in FIGS. 1 and 2, the camera module 1 includes: a reflective element 101; an optical system 102; an infrared cut filter 103; an imaging unit 104; and a housing 105.

The reflective element 101 is disposed closest to the object. The reflective element 101 reflects the object light emitted from the object and traveling along a first optical axis 111, and generates the object light traveling along a second optical axis 112. The reflective element 101 directs the generated object light, which travels along the second optical axis 112, toward the optical system 102. Hence, the reflective element 101 deflects an optical path of a light ray included in the object light. The reflective element 101 deflects the light ray at an angle of preferably 90°. The angle is formed between the first optical axis 111 and the second optical axis 112. However, the angle may be other than 90°. The reflective element 101 is desirably a prism formed with high processing precision. Note that the reflective element 101 may be a reflective member other than the prism. For example, the reflective element 101 may be a reflective plate. The reflective plate is also called a mirror.

If the camera module 1 including the reflective element 101 is provided to a smartphone, a direction of the optical axis can be deflected from a direction perpendicular to a back surface of the smartphone to a direction parallel with the back surface. Such a feature can reduce the thickness of the smartphone.

The optical system 102 is disposed behind the reflecting element 101. The optical system 102 collects the object light, which travels along the second optical axis 112, on an image forming surface 104a of the imaging unit 104. Thus, the object light forms an image of the object on the imaging forming surface 104a.

The infrared cut filter 103 is disposed behind the optical system 102. The infrared cut filter 103 cuts an infrared component from the object light collected on the image forming surface 104a of the imaging unit 104. The infrared cut filter 103 is disposed in front of the image forming surface 104a. Such a feature can keep a foreign object such as dust from directly adhering to the image forming surface 104a. Hence, the feature can keep the foreign object from blocking the light to be collected on the image forming surface 104a. Thus, the feature can reduce deterioration caused by the foreign object to an image generated of an image signal to be output from the camera module 1.

The imaging unit 104 has the imaging forming surface 104a on which the object light transmitted through the optical system 102 is collected. The imaging unit 104 is a sensor that photoelectrically converts the collected object light and outputs an electrical signal corresponding to the object light. The output electrical signal is processed by software and converted into an image. The imaging unit 104 is, for example, a complementary metal oxide semiconductor (CMOS) image sensor, or a charge coupled device (CCD) image sensor.

The housing 105 directly or indirectly supports the reflective element 101, the optical system 102, the infrared cut filter 103, and the imaging unit 104.

### 1.2 Optical System

As illustrated in FIG. 2, the optical system 102 includes: a first lens group G1; a second lens group G2; a third lens group G3; an aperture stop St, and a lens drive device 121.

The first lens group G1 receives the object light and transmits the received light. The first lens group G1 includes two or more lenses 131. The first lens group G1 has positive power as a whole.

In front of the first lens group G1, the reflective element 101 is disposed. Hence, the object light transmitted to the optical system 102 and received by the first lens group G1 is reflected on the reflecting element 101, and travels along the second optical axis 112.

The second lens group G2 is disposed behind the first lens group G1, and transmits the object light transmitted through the first lens group G1. The second lens group G2 includes at least one first lens 132. The second lens group G2 has negative power as a whole.

The third lens group G3 is disposed behind the second lens group G2, transmits the object light transmitted through the second lens group G2, and collects the transmitted object light on the imaging unit 104. The third lens group G3 includes at least one second lens 133. The third lens group G3 has positive power as a whole.

The first lens group G1, the second lens group G2, and the third lens group G3 are directly or indirectly supported by the housing 105 so that the optical axes of the optical system 102, the first lens group G1, the second lens group G2, and the third lens group G3 are aligned with the second optical axis 112.

The optical system 102 includes three lens groups including: the first lens group G1; the second lens group G2; and the third lens group G3. The optical system 102 may include four or more lens groups.

The aperture stop St is contained in the optical system 102, and limits a ray bundle of the object light transmitted through the optical system 102.

The lens drive device 121 drives the second lens group G2 in a direction parallel with, and perpendicular to, the second optical axis 112. The lens drive device 121 drives the second lens group G2 by driving force generated by such a component as a stepping motor, a piezoelectric element, or a voice coil motor (VCM); preferably, by the VCM that is small in size, low in price, and capable of generating large driving force. The lens drive device 121 is disposed between the housing 105 and the second lens group G2.

The first lens group G1, the third lens group G3, and the imaging unit 104 are secured to the housing 105. Hence, in focusing on an object found at a short distance, positioned at a distance closer than infinity, and emitting object light to be received by the first lens group G1, no change is observed in a distance between the first lens group G1 and the imaging unit 104 in a direction of the second optical axis 112, or in a distance between the third lens group G3 and the imaging unit 104 in the direction of the second optical axis 112.

If the second lens group G2 is driven in the direction parallel with the second optical axis 112, a point of focus moves in the direction parallel with the second optical axis 112. Hence, when the second lens group G2 is driven in the direction parallel with the second optical axis 112, focusing can be performed. Furthermore, if the second lens group G2 is driven in the direction perpendicular to the second optical axis 112, the image of the object moves on an image plane of the optical system 102 in the direction perpendicular to the second optical axis 112. Hence, when the second lens group G2 is driven in the direction perpendicular to the second optical axis 112, the OIS can be performed. Thus, when the second lens group G2 alone is driven, the camera module 1 can perform focusing and the OIS. Such features make it possible to reduce the sizes and thicknesses of the optical system 102 and the camera module 1.

1.3 Conditional Expressions that Optical System is to Satisfy

The optical system 102 satisfies Conditional Expressions 11 to 15 below where
f: An actual focal point of the first lens group G1, the second lens group G2, and the third lens group G3 as a whole,
f2: a focal point of the second lens group G2,
ih: a maximum image height of the first lens group G1, the second lens group G2, and the third lens group G3 as a whole,
TTL: a distance from a surface 141a of a lens 141 to the image forming surface 104a, the surface 141a facing the object and the lens 141 being included in the two or more lenses 131 and disposed closest to the object,
Fno: an F number of the first lens group G1, the second lens group G2, and the third lens group G3 as a whole,
d−OIS: an absolute value of a distance for which the second lens group G2 is driven in the direction perpendicular to the second optical axis 112, and
Ims: an absolute value of a distance for which the image moves in the direction perpendicular to the second optical axis 112 on the image plane of the optical system 102, the image moving when the second lens group G2 is driven in the direction perpendicular to the second optical axis 112.

−6.0<f/f2<−2.0 (11)

ih/f<0.4 (12)

0.7<TTL/f<1.0 (13)

1.6<Fno/7.0 (14)

IMS/d−OIS>1.5 (15)

Conditional Expression 11 defines a desirable range of a ratio of the focal point f of the optical system 102 to the focal point f2 of the second lens group G2. If the ratio is lower than, or equal to, a lower limit value of −6.0, the second lens group G2 is high in reflectivity. For this reason, when the camera module 1 performs focusing on the object at a short distance, the optical system 102 exhibits large variation in aberration. In particular, the optical system 102 exhibits large variation in field curvature and comatic aberration. On the other hand, if the ratio is higher than, or equal to, a higher limit value of −2.0, the second lens group G2 is low in reflectivity. For this reason, when the camera module 1 performs focusing on the object at a short distance, the second lens group G2 moves for a long distance. For these reasons, it is undesirable that the ratio is either lower than or equal to the lower limit value of −6.0, or higher than or equal to the higher limit value of −2.0.

Conditional Expression 12 defines a desirable range of a ratio of the maximum image height ih to the focal point f of the optical system 102. The desirable range determines a 35-mm-equivalent focal point of the optical system 102. If the ratio is lower than 0.4, the 35-mm-equivalent focal point of the optical system 102 is 50 mm or more. Hence, when a camera including the camera module 1 is combined with a camera having a 35-mm-equivalent focal point of, for example, 25 mm, a magnification of 2× or more can be achieved.

Conditional Expression 13 defines a desirable range of a telephoto ratio of the optical system 102. If the telephoto ratio is lower than, or equal to, a lower limit value of 0.7, the optical system 102 is small. However, the optical system 102 has large aberration. Furthermore, when the camera module 1 performs focusing on the object at a short distance, the optical system 102 exhibits large variation in aberration. In particular, the optical system 102 exhibits large variation in field curvature. On the other hand, if the telephoto ratio is an upper limit value of 1.0, the optical system 102 is large. For these reasons, it is undesirable that the ratio is either lower than, or equal to, 0.7, or higher than, or equal to, 1.0.

Conditional Expression 14 defines an F number Fno of the optical system 102. If the F number Fno is lower than, or equal to, a lower limit value of 1.6, the optical system 102 is large in thickness. Furthermore, the optical system 102 has large spherical aberration and comatic aberration. On the other hand, if the F number Fno is higher than, or equal to, an upper limit value of 7.0, the optical system 102 cannot receive light in large amount. Furthermore, the diffraction limit decreases a resolution of the optical system 102. For these reasons, it is undesirable that the F number Fno is either lower than, or equal to, 1.6, or higher than, or equal to, 7.0.

Conditional Expression 15 defines a desirable range of a ratio of the absolute value Ims of a moving distance of the image to the absolute value d−OIS of a moving distance of the second lens group G2. The ratio determines the OIS performance, of the optical system 102, achieved when the second lens group G2 is driven in the direction perpendicular to the second optical axis 112. If the ratio is higher than 1.5, the drive distance, of the second lens group G2, required to move the image when the second lens group G2 alone is driven is shorter than the drive distance, of the first lens group G1, the second lens group G2, and the third lens group G3 as a whole, required to drive the image by the same distance when the first lens group G1, the second lens group G2, and the third lens group G3 are driven as a whole. Hence, the OIS can be performed efficiently. Furthermore, the lens drive device 121 can be reduced in size.

Hence, when the optical system 102 satisfies Conditional Expressions 11 to 15, the optical system 102 and the camera module 1 having desirable optical performance can be reduced in size and thickness.

### 1.4 Lenses Included in Lens Groups

The two or more lenses 131 included in the first lens group G1 include: a first lens L1 having positive power; and a second lens L2 having negative power. The first lens L1 of the two or more lenses 131 is positioned closest to the reflective element 101.

The at least one first lens 132 included in the second lens group G2 includes a third lens L3 having negative power.

The at least one second lens 133 included in the third lens group G3 includes a fourth lens L4 having positive power.

Such features make it possible to reduce the sizes and thicknesses of the optical system 102 and the camera module 1.

The optical performance of the optical system 102 can be adjusted by the configurations of the first lens L1, the second lens L2, the third lens L3, and the fourth lens L4.

### 1.5 Conditional Expression to Be Satisfied by First Lens Group and Second Lens

### Group

If the distance a is between 50 mm and 3,000 mm, the first lens group G1 and the second lens group G2 satisfy Conditional Expression 16 below where
a: a distance from a principal point of the first lens group G1 and the second lens group G2 as a whole to an object at a short distance,
d−AF: a drive distance, of the second lens group G2, required for focusing from infinity to the object at a short distance, and
f2: a focal point of the second lens group G2.

a×d−AF/f2<0.3(50<a<3,000) (16)

Conditional Expression 16 defines the drive distance of the second lens group G2 required for performing focusing. When the first lens group G1 and the second lens group G2 satisfy Conditional Expression 16, the drive distance of the second lens group G2 can be reduced. Such a feature can simplify the lens drive device 121 that drives the second lens group G2.

### 1.6 Optical Image Stabilization

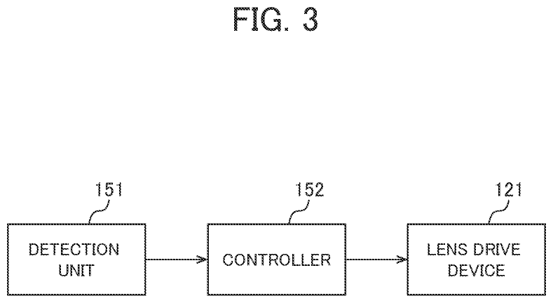

FIG. 3 is a block diagram of a control system included in the camera module of the first embodiment.

As illustrated in FIG. 3, the camera module 1 includes: a detection unit 151; and a controller 152.

The detection unit 151 detects a state of camera shake, and outputs a signal corresponding to the detected state of camera shake. The detection unit 151 includes an angular velocity sensor and an acceleration sensor.

The controller 152 controls the lens drive device 121 in accordance with the output signal. In order to perform the OIS, the controller 152 causes, in accordance with the output signal, the lens drive device 121 to drive the second lens group G2 in the direction perpendicular to the second optical axis 112. As the control of the lens drive device 121 for performing the OIS, a known control technique can be adopted.

Furthermore, in order to perform focusing, the controller 152 causes the lens drive device 121 to drive the second lens group G2 in the direction parallel with the second optical axis 112.

In addition to the second lens group G2, an element other than the second lens group G2 may be driven so that the OIS is performed. For example, in addition to the second lens group G2, some or all of the reflective element 101, the optical system 102, and the imaging unit 104 may be driven so that the OIS is performed.

If the reflective element 101 is driven so that the OIS is performed, the reflective element 101 is rotated about, for example, any given axis as a rotation axis so that the OIS is performed. In this case, the camera module 1 includes: a driving unit; and a holding member. The driving unit generates driving force for rotating the reflective element 101. The holding member holds the reflective element 101, and transmits the generated driving force to the reflective element 101 in order to rotate the reflective element 101. The driving unit is disposed, for example, between the reflective element 101 and the housing 105.

If the optical system 102 is driven so that the OIS is performed, the optical system 102 is moved, for example, in parallel with any given axis so that the OIS is performed. In this case, the camera module 1 includes: a driving unit; and a holding member. The driving unit generates driving force for moving the optical system 102. The holding member holds the optical system 102, and transmits the generated driving force to the optical system 102 in order to move the optical system 102.

If the imaging unit 104 is driven so that the OIS is performed, the imaging unit 104 is moved, for example, in parallel with any given axis so that the OIS is performed. In this case, the camera module 1 includes: a driving unit; and a holding member. The driving unit generates driving force for moving the imaging unit 104. The holding member holds the imaging unit 104, and transmits the generated driving force to the imaging unit 104 in order to move the imaging unit 104. The driving unit is disposed, for example, between the imaging unit 104 and the housing 105.

No matter which element is driven among the reflective element 101, the optical system 102, the imaging unit 104, and the second lens group G2, the OIS is performed by motion of an image of the object in a direction perpendicular to the second optical axis 112 on the image plane of the optical system 102. Hence, the OIS can also be performed by rotation or motion of a plurality of elements in a plurality of drive directions different from one another. For example, the OIS can also be performed when the reflective element 101 is rotated about one axis as a central axis and the second lens group G2 is moved in parallel with another axis.

If, in addition to the second lens group G2, an element other than the second lens group G2 is driven so that the OIS is performed, the structure of the camera module 1 and the control by the controller 152 could be complex, compared with a case where the OIS is performed when the second lens group G2 alone is driven. Hence, the production costs of the camera module 1 could rise. However, if, in addition to the second lens group G2, an element other than the second lens group G2 is driven so that the OIS is performed, the camera module 1 might be reduced in size. For example, the OIS is performed when the reflective element 101 is rotated about one axis as a central axis and the second lens group G2 is moved in parallel with another axis. In such a case, the OIS in a thickness direction of the camera module 1 can be performed by the rotation of the reflective element 101. Such a feature can reduce the space required to drive the second lens group G2 in the thickness direction of the camera module 1. Hence, the camera module 1 can be reduced in size.

### 1.7 Configuration Diagrams and Lens Data

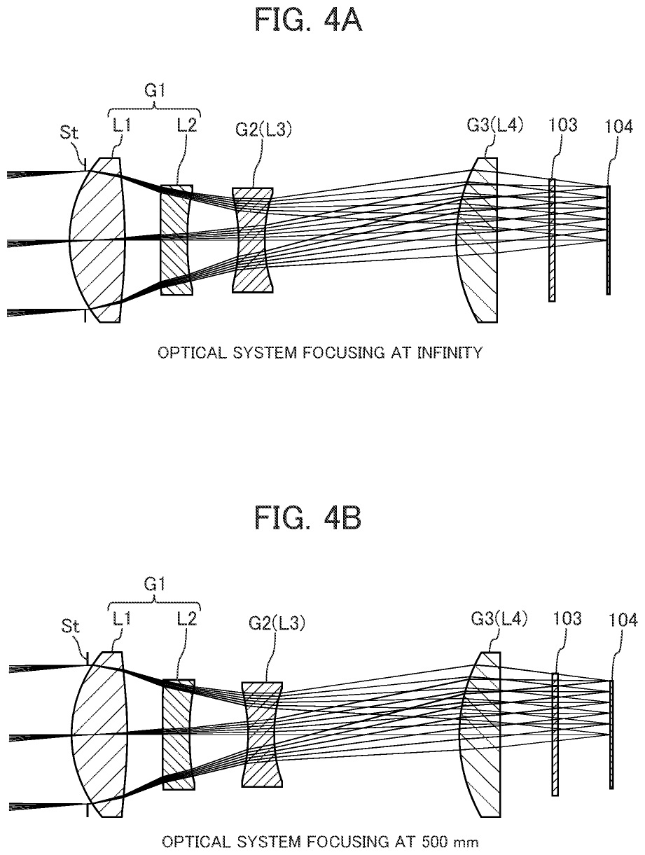

FIGS. 4A and 4B are configuration diagrams of the optical system included in the camera module of the first embodiment. FIG. 4A is a configuration diagram when the optical system focuses at infinity. FIG. 4B is a configuration diagram when the optical system focuses at 500 mm.

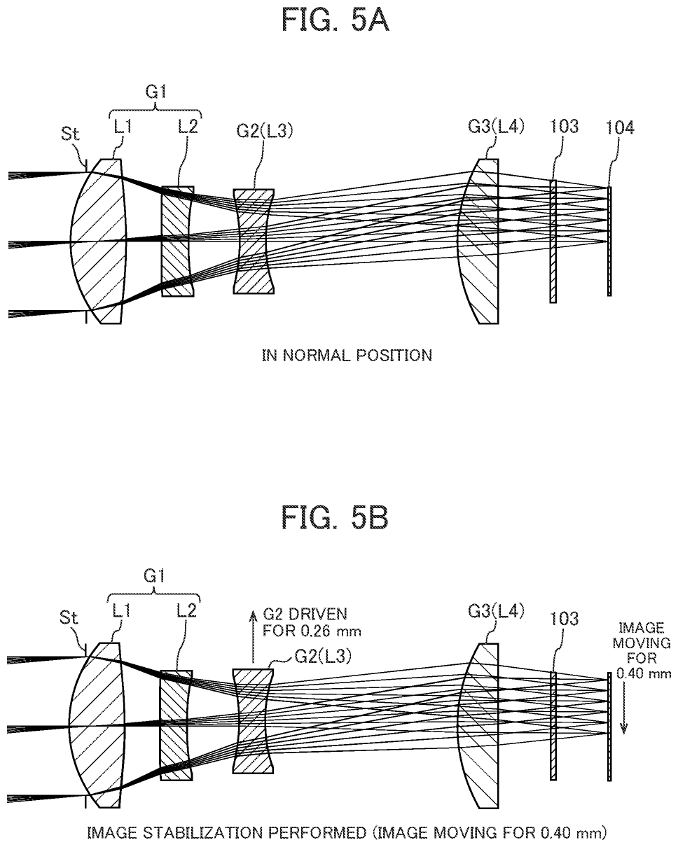

FIGS. 5A and 5B are configuration diagrams of the optical system included in the camera module of the first embodiment. FIG. 5A is a configuration diagram of the optical system when the optical system is in a normal position. FIG. 5B is a configuration diagram of the optical system when image stabilization is performed on the optical system.

As illustrated in FIGS. 4A, 4B, 5A, and 5B, the optical system 102 includes: the aperture stop St; the first lens group G1 having positive power as a whole, the second lens group G2 having negative power as a whole; and the third lens group G3 having positive power as a whole. In the optical system 102, the aperture stop St, the first lens group G1, the second lens group G2, and the third lens group G3 are arranged in the stated order from toward the object. The first lens group G1 includes: the first lens L1 having positive power; and the second lens L2 having negative power. The second lens group G2 includes the third lens L3 having negative power. The third lens group G3 includes the fourth lens L4 having positive power.

As illustrated in FIG. 5B, when the second lens group G2 is driven in the direction perpendicular to the second optical axis 112 and moved by 0.26 mm, an image of the object moves by 0.4 mm in the direction perpendicular to the second optical axis 112 on the image plane of the optical system 102.

Table 1 shows lens data of the optical system 102 included in the camera module 1 of the first embodiment.

TABLE 1
f = 23.0 mm (35-mm-equivalent f = 240 mm)
Fno = 4.4
ω = 5.1 deg.
ih = 2.06 mm
TTL = 20.6 mm
a = 500 mm
d-AF = 0.27 mm
Ims = 0.40 mm
d-OIS = 0.26 mm
Surface Data
(INF)

| Surface | Curvature Radius r | Surface Interval t | Refractive Index | Abbe's Number |
|---|---|---|---|---|
| Number i | (mm) | (mm) | Nd | νd |
| Subject | Infinity | Infinity | | |
| 1(Stop) | Infinity | −0.58 | | |
| 2* | 4.85 | 1.87 | 1.497 | 81.56 |
| 3* | −13.08 | 1.26 | | |
| 4* | 120.13 | 1.13 | 1.821 | 24.06 |
| 5* | 10.11 | 1.95 | | |
| 6* | −6.93 | 1.00 | 1.497 | 81.56 |
| 7* | 5.54 | 7.64 | | |
| 8* | 6.39 | 1.54 | 1.583 | 59.46 |
| 9 | Infinity | 2.00 | | |
| 10 | Infinity | 0.21 | 1.517 | 64.20 |
| 11 | Infinity | 2.00 | | |
| Imaging | Infinity | | | |
| Surface | | | | |

Asphericity Data

| | Surface 2 | Surface 3 | Surface 4 | Surface 5 | Surface 6 | Surface 7 | Surface 8 |
|---|---|---|---|---|---|---|---|
| k | 0.00E+00 | 0.00E+00 | 0.00E+00 | 0.00E+00 | 0.00E+00 | 0.00E+00 | 0.00E+00 |
| A4 | −3.66E−04 | 2.16E−03 | 5.73E−03 | 6.83E−03 | 3.89E−03 | 2.19E−03 | −2.02E−04 |
| A6 | −7.68E−07 | −5.72E−05 | −2.01E−04 | 1.38E−04 | −1.12E−03 | −8.28E−04 | 1.04E−05 |
| A8 | 5.97E−07 | 7.52E−07 | −6.30E−06 | −2.03E−05 | 4.78E−04 | 2.41E−04 | −1.44E −06 |
| A10 | 0.00E+00 | 0.00E+00 | 0.00E+00 | 0.00E+00 | −9.69E−05 | −2.34E−05 | 9.05E−08 |
| A12 | 0.00E+00 | 0.00E+00 | 0.00E+00 | 0.00E+00 | 7.45E−06 | 7.02E−07 | 0.00E+00 |

In Table 1, f denotes a focal point of the optical system 102 as a whole, Fno denotes an F number of the optical system 102 as a whole, ω denotes a half angle of view (degrees) of the optical system 102 as a whole, ih denotes a maximum image height of the optical system 102 as a whole, and TTL denotes a distance from the surface 141a of the lens 141 to the imaging unit 104, the surface 141a facing the object and the lens 141 being included in the two or more lenses 131 of the first lens group G1 and positioned closest to the reflective element 101. Furthermore, i denotes a surface number of a lens surface counted from toward the object, r denotes a curvature radius of the lens surface, t denotes a distance between lens surfaces on the second optical axis 112, Nd denotes a refractive index with respect to a d-line, and vd denotes an Abbe's number with respect to the d-line. In Table 1, * (asterisk) is added to a surface number of an aspherical lens surface.

An aspherical shape of the aspherical lens surface is expressed by Equation 1, where z is a position in a direction of the optical axis, h is a height in a direction perpendicular to the optical axis, k is the number of circular cones, and A4, A6, A8, A10, and A12 are aspherical coefficients. The same applies to Tables 2 to 5 to be described below.

$$z = \frac{\frac{{h}^{2}}{r}}{1 + \sqrt{1 - \frac{( 1 + k ) {h}^{2}}{{r}^{2}}}} + {A}_{4} {h}^{4} + {A}_{6} {h}^{6} + {A}_{8} {h}^{8} + {A}_{10} {h}^{10} + {A}_{12} {h}^{12} \qquad [ Math . 1 ]$$

If the optical system 102 has the lens data shown in Table 1, the optical system 102 has an actual focal point f of 23.0 mm. Furthermore, the optical system 102 has a 35-mm-equivalent focal point of approximately 240 mm. Hence, if a dual-lens camera includes: a telephoto camera provided with the camera module 1; and a wide-angle camera provided with a camera module including an optical system having a 35-mm-equivalent focal point of 24 mm, the dual-lens camera can have a magnification of approximately 10×.

If the optical system 102 has the lens data shown in Table 1, the optical system 102 has an actual focal point f of 23 mm. Furthermore, the focal point f2 is −5.87 mm. Moreover, the maximum image height ih is 2.05 mm. In addition, the distance TTL is 20.6 mm. Furthermore, the F-number Fno is 4.4. Moreover, if the absolute value d−OIS of the drive distance is 0.26 mm, the absolute value Ims of the moving distance is 0.40 mm.

Hence, the optical system 102 satisfies Conditional Expressions 11 to 15 described above.

Because the optical system 102 drives the second lens group G2 toward the image, the optical system 102 can perform focusing for imaging at infinity to a short distance. If the optical system 102 has the lens data shown in Table 1, the second lens group G2 has to be driven for a drive distance of 0.26 mm to perform focusing at an imaging distance of as close as 50 cm. This drive distance is shorter than 1.1 mm; that is, a lens-extending distance required for performing focusing by extension of the whole lens group at an imaging distance of as close as 50 cm.

Furthermore, the optical system 102 drives the second lens group G2 in the direction perpendicular to the second light axis 112. Hence, the optical system 102 can move the image to perform the OIS. If the imaging unit 104 is a 1/4.4 sensor, and the optical system 102 has a 35-mm-equivalent focal point of 240 mm, the image has to move for a moving distance of 0.40 mm when a shake angle of 1 degree is corrected. If the optical system 102 has the lens data shown in Table 1, the second lens group G2 is driven for a distance of just 0.26 mm so that the image successfully moves for a moving distance of 0.40 mm required when a shake angle of 1 degree is corrected.

Hence, the first embodiment can reduce the drive distance, of the second lens group G2, required for performing focusing. Furthermore, the first embodiment can reduce the drive distance, of the second lens group G2, required for performing the OIS.

### 2. Second Embodiment

Described below will be how a second embodiment is different from the first embodiment. Otherwise, the same configurations as those employed in the first embodiment are also employed in the second embodiment.

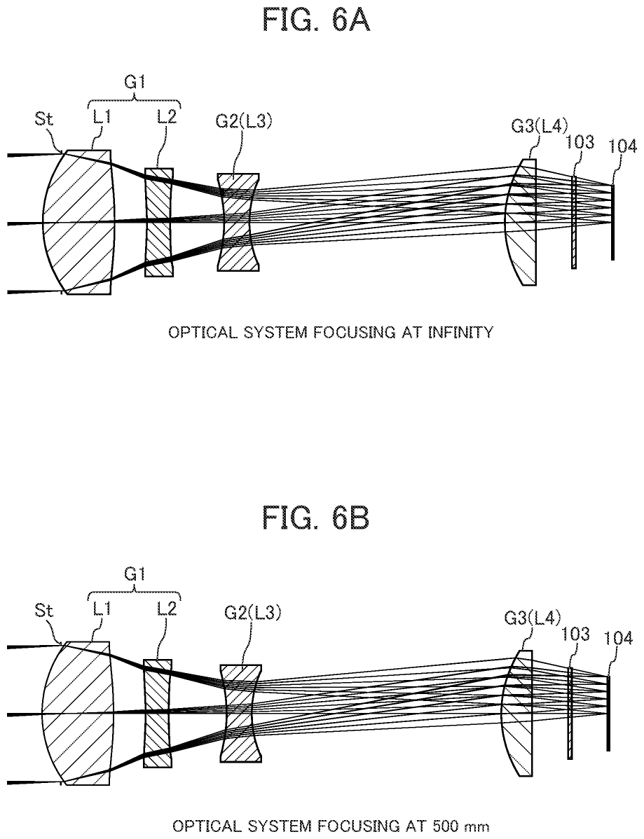

FIGS. 6A and 6B are configuration diagrams of the optical system included in the camera module of a second embodiment. FIG. 6A is a configuration diagram when the optical system focuses at infinity. FIG. 6B is a configuration diagram when the optical system focuses at 500 mm.

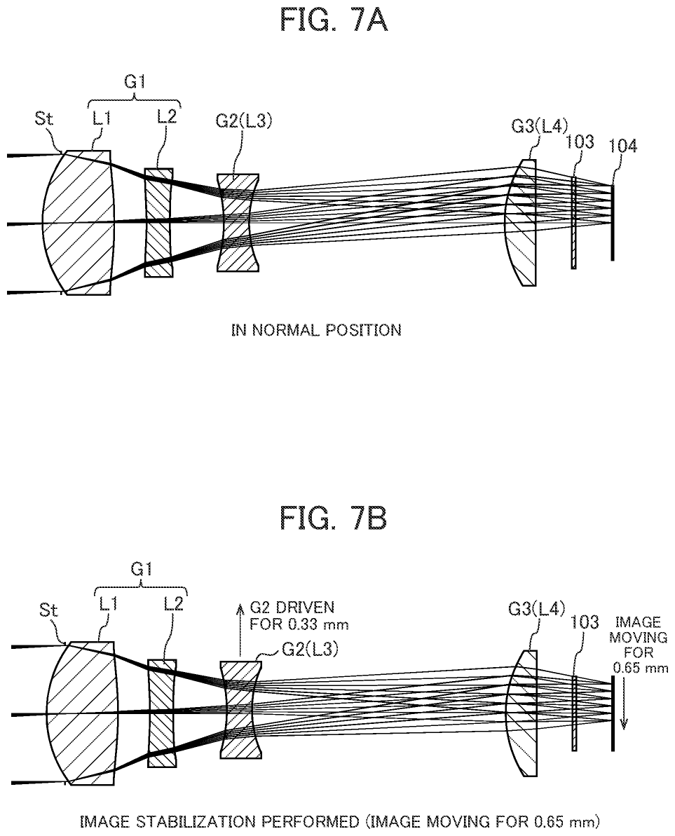

FIGS. 7A and 7B are configuration diagrams of the optical system included in the camera module of a second embodiment. FIG. 7A is a configuration diagram of the optical system when the optical system is in a normal position. FIG. 7B is a configuration diagram of the optical system when image stabilization is performed on the optical system.

Table 2 shows lens data of the optical system 102 included in the camera module 2 of the second embodiment.

TABLE 2
f = 38.1 mm (35-mm-equivalent f = 400 mm)
Fno = 4.9
ω = 3.1 deg.
ih = 2.05 mm
TTL = 31.6 mm
a = 1000 mm
d-AF = 0.24 mm
Ims = 0.65 mm
d-OIS = 0.33 mm
Surface Data
(INF)

| Surface | Curvature Radius r | Surface Interval t | Refractive Index | Abbe's Number |
|---|---|---|---|---|
| Number i | (mm) | (mm) | Nd | νd |
| Subject | Infinity | Infinity | | |
| 1(Stop) | Infinity | −1.04 | | |
| 2* | 6.46 | 3.96 | 1.497 | 81.56 |
| 3* | −17.83 | 1.79 | | |
| 4* | −19.94 | 1.30 | 1.821 | 24.06 |
| 5* | 63.50 | 3.00 | | |
| 6* | −7.24 | 1.00 | 1.497 | 81.56 |
| 7* | 6.21 | 14.62 | | |
| 8* | 6.52 | 1.70 | 1.589 | 61.25 |
| 9 | Infinity | 2.00 | | |
| 10 | Infinity | 0.21 | 1.517 | 64.20 |
| 11 | Infinity | 2.00 | | |
| Imaging | Infinity | | | |
| Surface | | | | |

Asphericity Data

| | Surface 2 | Surface 3 | Surface 4 | Surface 5 | Surface 6 | Surface 7 | Surface 8 |
|---|---|---|---|---|---|---|---|
| k | 0.00E+00 | 0.00E+00 | 0.00E+00 | 0.00E+00 | 0.00E+00 | 0.00E+00 | 0.00E+00 |
| A4 | −3.79E−05 | 9.79E−04 | 2.70E−03 | 2.87E−03 | 2.30E−03 | 7.80E−04 | −1.21E−04 |
| A6 | 3.61E−07 | −1.66E−05 | −9.71E−05 | −3.17E−05 | −10.42 | −6.54E−04 | −2.54E−06 |
| A8 | 2.32E−08 | 1.34E−07 | 4.80E−07 | −2.08E−07 | 2.29E−04 | 2.54E−04 | −4.01E−08 |
| A10 | 0.00E+00 | 0.00E+00 | 0.00E+00 | 0.00E+00 | −3.68E−05 | −4.61E−05 | 2.07E−09 |
| A12 | 0.00E+00 | 0.00E+00 | 0.00E+00 | 0.00E+00 | 2.24E−06 | 3.49E−06 | 0.00E +00 |

If the optical system 102 has the lens data shown in Table 2, the optical system 102 has an actual focal point f of 38.1 mm. Furthermore, the optical system 102 has a 35-mm-equivalent focal point of approximately 400 mm. Hence, if a dual-lens camera includes: a telephoto camera provided with the camera module 1; and a wide-angle camera provided with a camera module including an optical system having a 35-mm-equivalent focal point of 24 mm, the dual-lens camera can have a magnification of approximately 16.7×.

If the optical system 102 has the lens data shown in Table 2, the optical system 102 has an actual focal point f of 38.1 mm. Furthermore, the focal point f2 is —6.61 mm. Moreover, the maximum image height ih is 2.05 mm. In addition, the distance TTL is 31.6 mm. Furthermore, the F-number Fno is 4.9. Moreover, if the absolute value d−OIS of the drive distance is 0.33 mm, the absolute value Ims of the moving distance is 0.65 mm.

Hence, the optical system 102 satisfies Conditional Expressions 11 to 15 described above.

Because the optical system 102 drives the second lens group G2 toward the image, the optical system 102 can perform focusing for imaging at infinity to a short distance. If the optical system 102 has the lens data shown in Table 2, the second lens group G2 has to be driven for a drive distance of 0.24 mm to perform focusing at an imaging distance of as close as 1 m. This drive distance is shorter than 1.3 mm; that is, a lens-extending distance required for performing focusing by extension of the whole lens group at an imaging distance of as close as 1 m.

Furthermore, the optical system 102 drives the second lens group G2 in the direction perpendicular to the second light axis 112. Hence, the optical system 102 can move the image to perform the OIS. If the imaging unit 104 is a 1/4.4 sensor, and the optical system 102 has a 35-mm-equivalent focal point of 400 mm, the image has to move for a moving distance of 0.65 mm when a shake angle of 1 degree is corrected. If the optical system 102 has the lens data shown in Table 2, the second lens group G2 is driven for a distance of just 0.33 mm so that the image successfully moves for a moving distance of 0.65 mm required when a shake angle of 1 degree is corrected.

Hence, as seen in the first embodiment, the second embodiment can also reduce the drive distance, of the second lens group G2, required for performing focusing. Furthermore, the second embodiment can reduce the drive distance, of the second lens group G2, required for performing the OIS.

### 3. Third Embodiment

Described below will be how a third embodiment is different from the first embodiment. Otherwise, the same configurations as those employed in the first embodiment are also employed in the third embodiment.

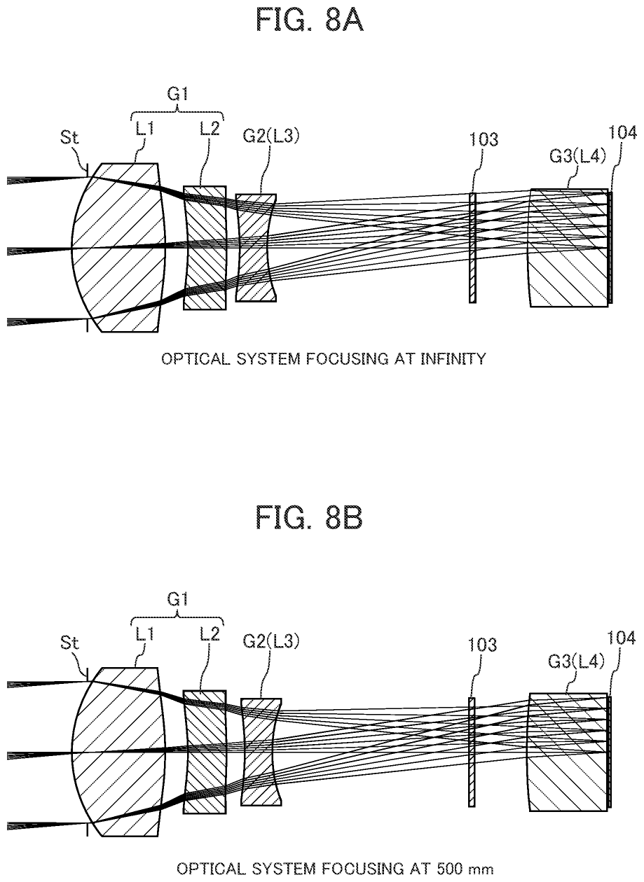

FIGS. 8A and 8B are configuration diagrams of the optical system included in the camera module of a third embodiment. FIG. 8A is a configuration diagram when the optical system focuses at infinity. FIG. 8B is a configuration diagram when the optical system focuses at 500 mm.

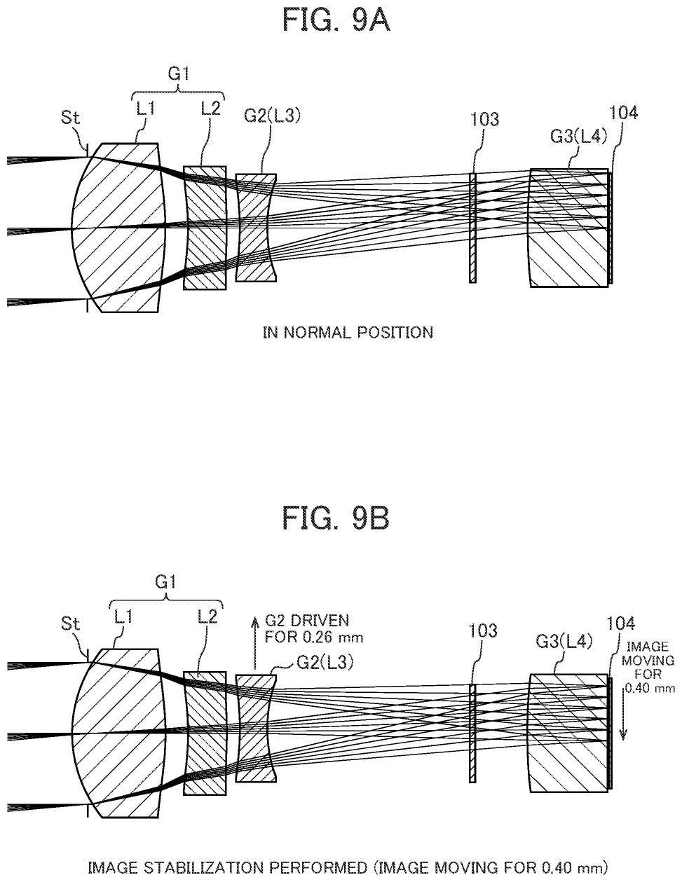

FIGS. 9A and 9B are configuration diagrams of the optical system included in the camera module of the third embodiment. FIG. 9A is a configuration diagram of the optical system when the optical system is in a normal position. FIG. 9B is a configuration diagram of the optical system when image stabilization is performed on the optical system.

Table 3 shows lens data of the optical system 102 included in the camera module 1 of the third embodiment.

TABLE 3
f = 23.0 mm (35-mm-equivalent f = 240 mm)
Fno = 4.3
ω = 5.1 deg.
ih = 2.05 mm
TTL = 20.1 mm
a = 500 mm
d-AF = 0.20 mm
Ims = 0.40 mm
d-OIS = 0.26 mm
Surface Data
(INF)

| Surface | Curvature Radius r | Surface Interval t | Refractive Index | Abbe's Number |
|---|---|---|---|---|
| Number i | (mm) | (mm) | Nd | νd |
| Subject | Infinity | Infinity | | |
| 1(Stop) | Infinity | −0.539 | | |
| 2* | 5.11 | 2.86 | 1.50 | 81.56 |
| 3* | −9.64 | 1.50 | | |
| 4* | −4.94 | 1.81 | 1.82 | 24.06 |
| 5* | −6.50 | 0.02 | | |
| 6* | −10.78 | 1.00 | 1.50 | 81.56 |
| 7* | 6.16 | 7.15 | | |
| 8* | Infinity | 2.10 | 1.52 | 64.20 |
| 9 | Infinity | 3.89 | | |
| 10 | 73.04 | 1.07 | 1.82 | 24.06 |
| 11 | Infinity | 0.05 | | |
| Imaging | Infinity | | | |
| Surface | | | | |

Asphericity Data

| | Surface 2 | Surface 3 | Surface 4 | Surface 5 | Surface 6 | Surface 7 | Surface 10 |
|---|---|---|---|---|---|---|---|
| k | 0.00E+00 | 0.00E+00 | 0.00E+00 | 0.00E+00 | 0.00E+00 | 0.00E+00 | 0.00E+00 |
| A4 | −2.03E−04 | 2.22E−03 | 7.16E−03 | 5.20E−03 | 3.96E−03 | 4.02E−03 | 7.86E−04 |
| A6 | −1.13E−06 | −6.46E−05 | −2.04E−04 | 2.49E−05 | −7.80E−04 | −7.31E−04 | 5.83E−04 |
| A8 | −5.49E−07 | 1.35E−06 | 5.79E−06 | −9.95E−07 | 1.69E−04 | 1.59E−04 | −9.55E−05 |
| A10 | 0.00E+00 | 0.00E+00 | 0.00E+00 | 0.00E+00 | −2.03E−05 | −1.78E−05 | 6.49E−06 |
| A12 | 0.00E+00 | 0.00E+00 | 0.00E+00 | 0.00E+00 | 1.01E−06 | 1.31E−06 | 0.00E +00 |

If the optical system 102 has the lens data shown in Table 3, the optical system 102 has an actual focal point f of 23.0 mm. Furthermore, the optical system 102 has a 35-mm-equivalent focal point of approximately 240 mm. Hence, if a dual-lens camera includes: a telephoto camera provided with the camera module 1; and a wide-angle camera provided with a camera module including an optical system having a 35-mm-equivalent focal point of 24 mm, the dual-lens camera can have a magnification of approximately 10×.

If the optical system 102 has the lens data shown in Table 3, the optical system 102 has an actual focal point f of 23.0 mm. Furthermore, the focal point f2 is −7.12 mm. Moreover, the maximum image height ih is 2.05 mm. In addition, the distance TTL is 20.1 mm. Furthermore, the F-number Fno is 4.3. Moreover, if the absolute value d−OIS of the drive distance is 0.26 mm, the absolute value Ims of the moving distance of the image is 0.40 mm.

Hence, the optical system 102 satisfies Conditional Expressions 11 to 15 described above.

Because the optical system 102 drives the second lens group G2 toward the image, the optical system 102 can perform focusing for imaging at infinity to a short distance. If the optical system 102 has the lens data shown in Table 3, the second lens group G2 has to be driven for a drive distance of 0.2 mm to perform focusing at an imaging distance of as close as 50 cm. This drive distance is shorter than 1.1 mm; that is, a lens-extending distance required for performing focusing by extension of the whole lens group at an imaging distance of as close as 50 cm.

Furthermore, the optical system 102 drives the second lens group G2 in the direction perpendicular to the second light axis 112. Hence, the optical system 102 can move the image to perform the OIS. If the imaging unit 104 is a 1/4.4 sensor, and the optical system 102 has a 35-mm-equivalent focal point of 240 mm, the image has to move for a moving distance of 0.40 mm when a shake angle of 1 degree is corrected. If the optical system 102 has the lens data shown in Table 3, the second lens group G2 is driven for a distance of just 0.26 mm so that the image successfully moves for a moving distance of 0.40 mm required when a shake angle of 1 degree is corrected.

Hence, as seen in the first embodiment, the third embodiment can also reduce the drive distance, of the second lens group G2, required for performing focusing. Furthermore, the third embodiment can reduce the drive distance, of the second lens group G2, required for performing the OIS.

### 4. Fourth Embodiment

Described below will be how a fourth embodiment is different from the first embodiment. Otherwise, the same configurations as those employed in the first embodiment are also employed in the fourth embodiment.

In the first embodiment, the second lens group G2 is driven toward the image and moved in relation to the first lens group G1, so that the first lens group G1 and the second lens group G2 are separated from each other. This is how focusing is performed for imaging at infinity to a short distance. However, the second lens group G2 does not have to be driven. The first lens group G1 may be moved in relation to the second lens group G2, so that the first lens group G1 and the second lens group G2 are separated from each other for performing focusing. Hence, in the fourth embodiment, the first lens group G1 is driven toward the object and the second lens group G2 is moved in relation to the first lens group G1, so that the first lens group G1 and the second lens group G2 are separated from each other for performing focusing.

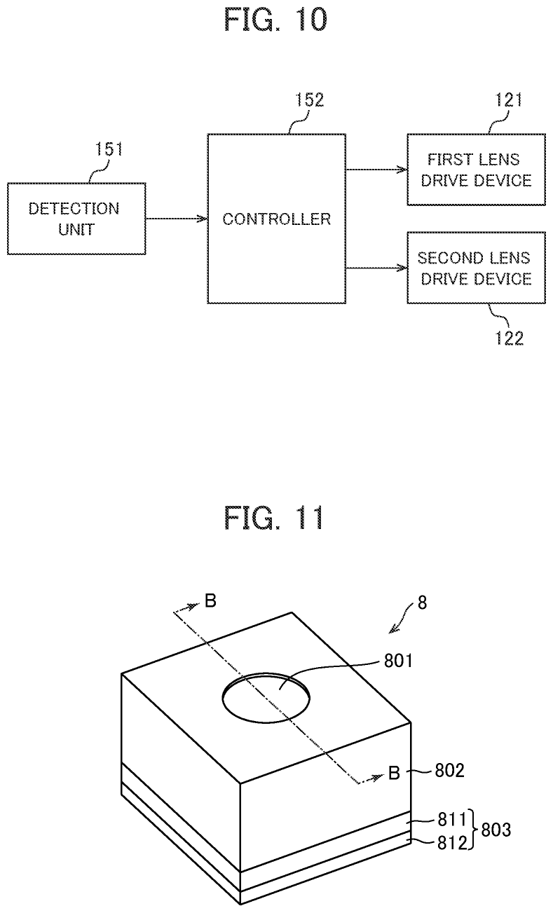

FIG. 10 is a block diagram of a control system included in the camera module of the fourth embodiment.

As illustrated in FIG. 10B, in the fourth embodiment, the optical system 102 includes the lens drive device 121, and, additionally, a lens drive device 122.

The lens drive device 121 drives the second lens group G2 only in a direction perpendicular to the second optical axis 112. The lens drive device 122 drives the first lens group G1 only in a direction parallel with the second optical axis 112. Hereinafter, the former lens drive device 121 is referred to as a first lens drive device, and the latter lens drive device 122 is referred to as a second lens drive device.

The second lens drive device 122 drives the first lens group G1 by driving force generated by such a component as a stepping motor, a piezoelectric element, or a VCM; preferably, by the VCM.

If the first lens group G1 is driven in the direction parallel with the second optical axis 112, a point of focus moves in the direction parallel with the second optical axis 112. Hence, the first lens group G1 is driven in the direction parallel with the second optical axis 112, so that focusing can be performed. Furthermore, if the second lens group G2 is driven in the direction perpendicular to the second optical axis 112, the image of the object moves on an image plane of the optical system 102 in the direction perpendicular to the second optical axis 112. Hence, when the second lens group G2 is driven in the direction perpendicular to the second optical axis 112, the OIS can be performed.

In focusing on an object found at a short distance, no change is observed in a distance between the second lens group G2 and the imaging unit 104 in the direction of the second optical axis 112, or in a distance between the third lens group G3 and the imaging unit 104 in the direction of the second optical axis 112.

The first lens group G1 includes: the first lens L1 having positive power; and the second lens L2 having negative power. The second lens group G2 includes the third lens L3 having negative power. The third lens group G3 includes the fourth lens L4 having positive power. Such features make it possible to reduce the sizes and thicknesses of the optical system 102 including the first lens group G1, the second lens group G2, and the third lens group G3, and the camera module 1.

Table 1 above also shows lens data of an optical system included in the camera module of the fourth embodiment.

Because the optical system 102 drives the first lens group G1 toward the object, the optical system 102 can perform focusing for imaging at infinity to a short distance. If the optical system 102 has the lens data shown in Table 1, the first lens group G1 has to be driven for a drive distance of 0.25 mm to perform focusing at an imaging distance of as close as 50 cm. This drive distance is shorter than 1.1 mm; that is, a lens-extending distance required for performing focusing by extension of the whole lens group at an imaging distance of as close as 50 cm.

Furthermore, the optical system 102 drives the second lens group G2 in the direction perpendicular to the second light axis 112. Hence, the optical system 102 can move the image to perform the OIS. As can be seen in the first embodiment, if the imaging unit 104 is a 1/4.4 sensor, and the optical system 102 has a 35-mm-equivalent focal point of 240 mm, the image has to move for a moving distance of 0.40 mm when a shake angle of 1 degree is corrected. If the optical system 102 has the lens data shown in Table 1, the second lens group G2 is driven for a distance of just 0.26 mm so that the image successfully moves for a moving distance of 0.40 mm required when a shake angle of 1 degree is corrected.

Hence, as seen in the first embodiment, the fourth embodiment can also reduce the drive distance, of the first lens group G1, required for performing focusing. Furthermore, the third embodiment can reduce the drive distance, of the second lens group G2, required for performing the OIS.

In addition to, or instead of, driving the first lens group G1 by the second lens drive device 122, a focal point of a variable focus lens disposed before the first lens group G1 may be changed by the second lens drive device 122 for performing focusing. Such a feature makes it possible to obtain an image at a nearer distance. The variable focus lens is such a lens as a liquid lens or a polymer lens.

In the fourth embodiment, the optical system 102 has lens data shown in Table 1. However, the optical system 102 may have the lens data shown in Table 2 or Table 3.

### 5. First Comparative Example

FIG. 11 is a perspective view schematically illustrating a camera module of a first comparative example.

A camera module 8 of the first comparative example illustrated in FIG. 11 is a straight camera module having a straight optical system. The camera module 8 performs focusing on an object by extension of the whole lens group.

As illustrated in FIG. 11, the camera module 8 includes: an optical unit 801; a lens drive device 802; and an imaging unit 803.

The optical unit 801 is an image optical system. Hence, the optical unit 801 guides light from a subject to the imaging unit 803 to form an image of the subject. The optical unit 801 is held inside the lens drive device 802.

The lens drive device 802 drives the optical unit 801.

The imaging unit 803 photoelectrically converts the guided light.

As illustrated in FIG. 11, the imaging unit 803 includes: a sensor unit 811; and a substrate

The sensor unit 811 is mounted on the substrate 812. On the substrate 812, the sensor unit 811 and the lens drive device 802 are stacked on top of each other in the stated order in the direction of the light axis. Hereinafter, the direction toward the optical unit 801 is referred to as “above”. Furthermore, the direction toward the imaging unit 803 is referred to as “below”.

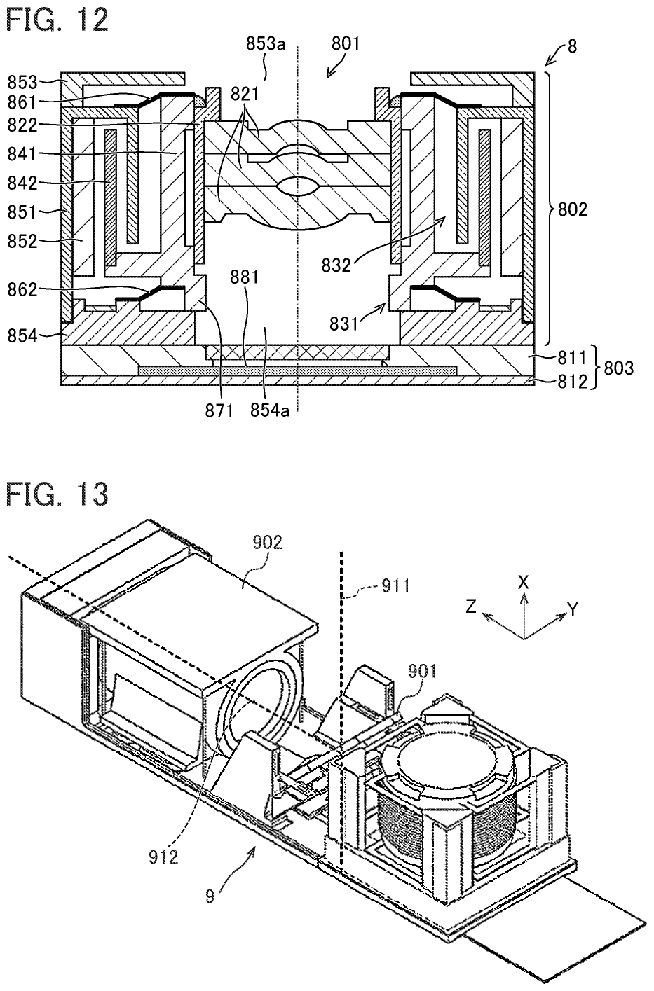

FIG. 12 is a cross-sectional view schematically illustrating a cross-section of the camera module of the first comparative example, taken along line B-B in FIG. 11. FIG. 12 illustrates a cross-section obtained when a center portion of the camera module of the first comparative example is cut in the direction of the optical axis of the camera module.

As illustrated in FIG. 12, the optical unit 801 includes: a plurality of imaging lenses 821; and a lens barrel 822. FIG. 12 illustrates the plurality of imaging lenses 821 as three imaging lenses.

The lens barrel 822 holds the imaging lenses 821. The lens barrel 822 is secured to the lens drive device 802. An optical axes of the imaging lenses 821 are aligned with an axial center of the lens barrel 822.

The lens drive device 802 is a VCM drive device. Hence, the lens drive device 802 uses electromagnetic force to drive the optical unit 801 in the direction of the optical axis. Thus, the lens drive device 802 causes the optical unit 801 to vertically move the imaging lenses 821 within a range between an infinity end to a macro end. This is how the camera module 8 carries out an autofocus function. The camera module 8 extends the lens barrel 822 holding a set of the imaging lenses 821. Hence, the camera module 8 extends the whole lens group to perform focusing on an object.

As illustrated in FIG. 12, the lens drive device 802 includes: a movable unit 831; and a stationary unit 832.

When the imaging lenses 821 are driven, the movable unit 831 moves along the optical axis to move the optical unit 801, including the imaging lenses 821, in the direction of the optical axis. The movable portion 831 is housed inside the stationary unit 832.

The stationary unit 832 does not move when the imaging lenses 821 are driven. Hence, a position of the stationary unit 832 does not change when the imaging lenses 821 are driven.

As illustrated in FIG. 12, the movable unit 831 includes: a lens holder 841; and a coil 842. Furthermore, the stationary unit 832 includes: a yoke 851; a permanent magnet 852; a cover 853; and a base 854.

The coil 842 is secured to an outer peripheral end portion (a flange portion) of the lens holder 841. The coil 842 extends from the outer peripheral end portion of the lens holder 841 toward incoming light (toward an opening 853a).

The base 854 forms a bottom portion of the lens drive device 802. On a back surface of the base 854, the sensor unit 811 is disposed. In a center portion of the base 854, an opening 854a is formed. The opening 854a is formed to define an optical path.

The yoke 851 is a tubular member. The yoke 851 forms a side surface portion of the lens drive device 802. The movable portion 831 houses therein the movable unit 831. The yoke 851 is secured to the base 854. Above the yoke 851, the cover 853 is disposed. The cover 853 forms an upper portion of lens drive device 802. Hence, the cover 853 includes a top surface that the lens drive device 802 has.

On an inner side surface of the yoke 851, a magnetic circuit including the permanent magnet 852 is disposed. The magnetic circuit faces the coil 842.

The lens drive device 802 drives the imaging lenses 821 in the direction of the optical axis by electromagnetic force generated by the coil 842 and the permanent magnet 852. The lens drive device 802 drives the imaging lenses 821 and the lens holder 841 in the direction of the optical axis by force generated of a current running through the coil 842 that is in a magnetic field formed by the permanent magnet 852.

As illustrated in FIG. 12, the lens drive device 802 includes: a leaf spring 861; and a leaf spring 862.

The leaf spring 861 and the leaf spring 862 are respectively disposed on an upper surface (the top surface) and a lower surface (a bottom surface) of the lens holder 841. The leaf spring 861 and the leaf spring 862 press the lens holder 841 in the direction of the optical axis. The leaf spring 861 and the leaf spring 862 secondarily support the lens holder 841 by elastic force so that the lens holder 841 is movable in the direction of the optical axis. Each of the leaf spring 861 and the leaf spring 862 has a spiral planar shape. Each leaf spring has one end secured to the movable unit 831. Each leaf spring has another end secured to the stationary unit 832.

When the camera module 8 is assembled, a protrusion 871 formed on the bottom surface of the lens holder 841 comes into contact with the base 854. Furthermore, by elastic force of the leaf spring 861 and the leaf spring 862, the lens holder 841 is biased downwards.

The thickness of the camera module 8, which is a straight camera module, is determined by: an optical length from a tip end of the imaging lenses 821 to a surface of an imaging element 881 included in the sensor unit 811; thicknesses of, for example, the imaging element 881 and the substrate 812; and a whole-lens-group extending distance for focusing of the imaging lenses 821. A sum of the optical length and the whole-lens-group extending distance is referred to as an optical total length. Typically, the optical length is proportional to a focal point of the optical unit 801.

Furthermore, as represented by the equations below, the whole-lens-group extending distance is approximately proportional to the square of the focal point.

1/a+1/b=1/f−>b=af/(a−f)

d=b−f=f2/(a−f)≈f2/a (where f<<a)

Here, a is a distance from a principal point of the optical unit 801 to the subject. Furthermore, b is a distance from the principal point to an image forming surface. Moreover, f is a focal point of the optical unit 801, and d is the whole-lens-group extending distance of the optical unit 801 required for focusing from infinity to a position at the distance a from the principal point.

The camera module 8, which is a straight camera module, mainly employs a wide-angle lens. For example, a wide-angle lens to be employed has a 35-mm-equivalent focal point of approximately 25 mm. If the camera module 8 employs a wide-angle lens having a 35-mm-equivalent focal point of approximately 25 mm, and the imaging element is a ½ sensor, the optical length is 5 mm. Furthermore, according to the above equations, a whole-lens-group extending distance of approximately 0.2 mm is required for performing focusing at a distance of 10 cm.

Recent years have seen emergence of such electronic devices as smartphones each including a plurality of camera modules. An electronic device including a plurality of camera modules is referred to as, for example, a multi-lens electronic device or a multi-camera electronic device. The electronic device includes, for example, a camera module including a wide-angle lens, and additionally, a camera module including a super-wide-angle lens or a telephoto lens. The electronic device digitally corrects an image obtained with a plurality of cameras, and provides a user with such usability as if the electronic device were equipped with a zoom camera.

If a dual-lens camera is set to have a magnification of 4× when the wide-angle camera module has a wide lens set to have a 35-mm-equivalent focal point of 25 mm, the telephoto camera module has to have the telephoto lens set to have a 35-mm-equivalent focal point of 100 mm. If the imaging element included in the telephoto camera module is a ½ sensor, the optical length is 19 mm when the telephoto lens is set to have a 35-mm-equivalent focal point of 100 mm. Furthermore, the whole-lens-group extending distance is approximately 4.2 mm. For this reason, the telephoto camera module is approximately four times as thick as the wide-angle camera module similarly including a ½ sensor. This problem might not be solved even if the size is reduced of the imaging element included in the telephoto camera module in order to reduce the thickness of the telephoto camera module. For example, even if the imaging element included in the telephoto camera module is a ¼ sensor, the optical length is 10 mm. Furthermore, the whole-lens-group extending distance is approximately 1.2 mm. For this reason, the telephoto camera module is approximately twice as thick as the wide-angle camera module including a ½ sensor.

### 6. Second Comparative Example

FIG. 13 is a perspective view schematically illustrating a camera module of a second comparative example.

A camera module 9 of the second comparative example illustrated in FIG. 13 is a foldable camera module including a foldable optical system. Because the camera module 9 is a foldable camera module, the thickness of the camera module 9 can be reduced even if the camera module 9 includes a telephoto lens.

As illustrated in FIG. 13, the camera module 9 includes a reflective element 901. The reflective element 901 is, for example, a mirror or a prism. In the camera module 9, the reflective element 901 can deflect the direction of the optical axis from a direction 911 perpendicular to a back surface of a smartphone including the camera module 9 to a direction 912 parallel with the back surface.

However, if the camera module 9, which is a foldable camera module, performs focusing by extension of the whole-lens-group, a clearance has to be provided between a lens barrel 902 and the reflective element 901. The clearance has to be greater than, or equal to, a distance for which a whole-lens-group of the lens barrel 902 is extended by the lens drive device. In the clearance, a light ray spreads out. The spreading light ray is sized according to an angle of view of the camera module 9. For this reason, the reflective element 901 is large. The large reflective element 901 inevitably increases the size of the camera module 9, making it difficult to reduce the size and thickness of the camera module 9.

Furthermore, if the camera module 9 includes a lens drive device having a large whole-lens-group extending distance, the camera module 9 is large. This problem also makes it difficult to reduce the size and thickness of the camera module 9.

Moreover, if the lens drive device has a large whole-lens-group extending distance, and, as a result, the lens drive deice becomes large in size, power consumption of the lens drive device increases. This increase in power consumption reduces a battery life of the electronic device. Such a problem makes it difficult to reduce the size of the electronic device, and increases the costs of a battery to be included in the electronic device.

As to a VCM lens drive device, a movable unit included in the lens drive device is often supported with a spring regardless of whether a camera module including the lens drive device is a straight camera module or a foldable camera module. The repulsive force of the spring has to be increased with an increase in a focal point and a whole-lens-group extending distance of an imaging optical system included in the camera module. For this reason, thrust force to be generated by the lens drive device has to be increased with an increase in the focal point and the whole-lens-group extending distance of the imaging optical system. Furthermore, as the focal point and the whole-lens-group extending distance of the imaging optical system increase, deformation of, and strain on, the spring increase. The increase in the strain on the spring induces a tilt of an operating axis of the lens drive device with respect to the optical axis. The induced tilt deteriorates quality of an obtained image.

### 7 Advantages of Camera Module of First to Third Embodiments over Camera Modules of First and Second Comparative Examples

Because the optical system 102 included in the camera module 1 of the first to third embodiments has the above-described configuration, the camera module 1 and the optical system 102 included in the camera module 1 can be made small and thin, making it possible to overcome the problems of the camera module 8 of the first comparative example and the camera module 9 of the second comparative example.

The present disclosure is not limited to the above-described embodiments, and may be replaced with a configuration substantially the same as, a configuration having the same advantageous effects as, or a configuration capable of achieving the same object as the configurations described in the above-described embodiments.

1. An optical system, comprising:
a first lens group including two or more lenses, having positive power as a whole, and configured to transmit object light;
a second lens group including at least one first lens, having negative power as a whole, disposed behind the first lens group, and configured to transmit the object light;
a third lens group including at least one second lens, having positive power as a whole, disposed behind the second lens group, and configured to collect the object light on an imaging unit; and
a lens drive device configured to drive the second lens group in a direction perpendicular to an optical axis of the optical system,
wherein, in focusing on an object found at a short distance and emitting the object light, no change is observed in a distance between the third lens group and the imaging unit in a direction of the optical axis,
if the second lens group is driven in the direction perpendicular to the optical axis, an image moves on an image plane of the optical system in the direction perpendicular to the optical axis, and
the optical system satisfies:
−6.0<f/f2<−2.0
ih/f<0.4
0.7<TTL/f<1.0
1.6<Fno/7.0
IMS/d−OIS>1.5 where
f: an actual focal point of the first lens group, the second lens group, and the third lens group as a whole,
f2: a focal point of the second lens group,
ih: a maximum image height of the first lens group, the second lens group, and the third lens group as a whole,
TTL: a distance from a surface of a lens to an image forming surface, the surface facing the object and the lens being included in the two or more lenses and disposed closest to the object,
Fno: an F number of the first lens group, the second lens group, and the third lens group as a whole,
d−OIS: an absolute value of a distance for which the second lens group is driven in the direction perpendicular to the optical axis, and
Ims: an absolute value of a distance for which the image moves in the direction perpendicular to the optical axis on the image plane, the image moving when the second lens group is driven in the direction perpendicular to the optical axis.

2. The optical system according to claim 1,
wherein the two or more lenses include: a first lens having positive power; and a second lens having negative power,
the at least one first lens includes a third lens having negative power, and
the at least one second lens includes a fourth lens having positive power.

3. The optical system according to claim 1,
wherein if a distance a is between 50 mm and 3,000 mm, the first lens group and the second lens group satisfy an expression of
a×d−AF/f2<0.3(50<a<3,000) where
a: a distance from a principal point of the first lens group and the second lens group as a whole to the object at the short distance,
d−AF: a drive distance, of the second lens group, required for focusing from infinity to the object at the short distance.

4. The optical system according to claim 1,
wherein the lens drive device drives the second lens group by driving force generated by a voice coil motor.

5. The optical system according to claim 1,
wherein the lens drive device drives the second lens group in a direction parallel with the optical axis, and
in the focusing, no change is observed in a distance between the first lens group and the imaging unit in the direction of the optical axis.

6. A camera module, comprising:
the optical system according to claim 1; and
a imaging unit,
wherein the imaging unit has an imaging forming surface on which the object light is collected, and photoelectrically converts the object light.

7. The camera module according to claim 6, further comprising
a reflective element disposed before the first lens group, and configured to reflect a object light traveling along a first optical axis and to generate a object light traveling along a second optical axis,
wherein the optical system collects the object light, which travels along the second optical axis, on the image forming surface.
